(19) United States
(12) Patent Application Publication
(10) Pub. No.: US 2005/0080892 A1
(43) Pub. Date: Apr. 14, 2005

(54) Method for predicting a development over time of a system quantity

(76) Inventors: Manfred Moser, Reutlingen (DE); Sonja Fritze, Reutlingen (DE); Michael Pfeiffer, Reutlingen (DE)

Correspondence Address: KENYON & KENYON, ONE BROADWAY, NEW YORK, NY, 10004, US

(21) Appl. No.: 10/943,200

(22) Filed: Sep. 16, 2004

(30) Foreign Application Priority Data
Oct. 8, 2003 (DE) 103 46 612.6

(51) Int. Cl. G06F 15/173

(52) U.S. Cl. 709/223

(57) ABSTRACT

A method for predicting a development over time of a system quantity (WP, 41, 42, 43, 44, 6) of a system (2), to which a number of system quantities (WP, 41, 42, 43, 44, 6) are assigned, a sequence of one of the system quantities (WP, 41, 42, 43, 44, 6) in each case being characterized by at least one event, wherein a delay of the at least one event is detected. On this basis, at least one actual value (I) over time for at least one event of at least one system quantity (WP, 41, 42, 43, 44, 6) is calculated within one measurement period to be predicted. The present invention makes it possible to provide a prediction of the system (2) or of one or a plurality of system quantities (WP, 41, 42, 43, 44, 6) based on flexible measurement periods. A future development of the system (2) or of the at least one system quantity (WP, 41, 42, 43, 44, 6) may not only be estimated roughly but instead may be calculated reliably under consideration of measurable data. The method makes reliable planning for future sequences of the at least one system quantity (WP, 41, 42, 43, 44, 6) and even of the entire system (2) possible.

### BACKGROUND OF THE INVENTION

1. Field of the Invention

The invention relates to a method for predicting a development over time of a system quantity, a device for predicting a development over time of a system quantity, a computer program, and a computer program product.

2. Description of Related Art

Commercially sold project planning tools, such as MS Project or SAP-PS, are presently known. These project planning tools are provided within a business process for project tracking, analysis, proactive resource management, or for data exchange with other systems.

Strategies used for improving business processes use either no drivers or only poorly defined ones. Such drivers usually do not allow any direct inferences as to the causes of errors and the like.

### SUMMARY OF THE INVENTION

It is an object of the invention to improve the possibility for observing and/or monitoring a system in general, which in its totality may be configured to have any desired complexity.

These and other objects of the invention are achieved by a method for predicting a development over time of a system quantity (WP, 41, 42, 43, 44, 6) of a system (2), to which a number of system quantities (WP, 41, 42, 43, 44, 6) are assigned, a sequence in each case of one of the system quantities (WP, 41, 42, 43, 44, 6) being characterized by at least one event, in which a delay of the at least one event is detected and, based on it, at least one actual value (I) over time is calculated for at least one event of at least one system quantity (WP, 41, 42, 43, 44, 6) within a measurement time period to be predicted. The invention also provides a device for predicting a development over time of a system quantity (WP, 41, 42, 43, 44, 6) of a system (2), to which a number of system quantities (WP, 41, 42, 43, 44, 6) are assigned, a sequence in each case of one of the system quantities (WP, 41, 42, 43, 44, 6) being characterized by at least one event, the device having at least one electronic device (3) which detects a delay of the at least one event, and the device having at least one electronic computing unit (10) which, based on it, calculates at least one actual value (I) over time for at least one event of at least one system quantity (WP, 41, 42, 43, 44, 6) within a measurement time period to be predicted. The invention also provides a corresponding computer program having program code means in order to implement the above described method when the computer program is run on a computer or a corresponding electronic computing unit (9) of the above described device. Finally, there is provided a computer program product having program code means, which are stored on a computer-readable data medium in order to implement the above described method when the computer program is run on a computer or a corresponding electronic computing unit (9) of the above described device.

### BRIEF DESCRIPTION OF THE DRAWINGS

The invention will be described in greater detail with reference to the following drawings wherein:

FIG. 1 shows a schematic representation of one embodiment of a system.

FIG. 2 shows a schematic representation of a preferred embodiment of the device of the present invention.

### DETAILED DESCRIPTION OF THE INVENTION

In the method according to the present invention for predicting a development over time of a system quantity of a system to which a number of system quantities are assigned, a sequence of one of the system quantities in each case being characterized by at least one event, a delay of the at least one event is detected. On this basis, at least one actual value over time is calculated for at least one event of at least one system quantity within one measurement period to be predicted. The present invention makes it possible to provide a prediction of the system or of one or a plurality of system quantities based on flexible measurement periods. A future development of the system or of the at least one system quantity may not only be estimated roughly but instead may be calculated reliably under consideration of measurable data. The method makes reliable planning for future sequences of the at least one system quantity and even of the entire system possible.

It may be provided that the at least one actual value is calculated under consideration of at least one time buffer between at least two system quantities. It is thus possible to predict the behavior of a higher-level system quantity which must be regarded as a package of a number of system quantities to which these system quantities are assigned. It is thus possible to consider a interaction over time between the individual system quantities, which are assigned to the higher-level system quantity. Delays prevailing within the higher-level system quantity at a point in time are thus detected. Under consideration of the at least one time buffer between the at least two system quantities, it is, for example, possible to calculate actual starts and actual ends, i.e., points in time, that limit a sequence over time of the at least one system quantity. Such a calculation may relate to system quantities which take place in the measurement time period to be predicted, i.e., not only planned system quantities.

In another embodiment of the present invention, a delay reason is assigned to the delay from a number of predetermined, system-specific delay reasons. It is thus possible to perform an analysis of delay reasons of any combination of system quantities. For each system quantity started or ended with a delay, a starting and ending delay reason is determined from a common value inventory. On this basis, it is possible to perform a Pareto analysis of the delay reasons of individual types of system quantities or of any combination of types of system quantities.

In a possible embodiment of the present invention, it is provided that the system is designed as a project landscape. A system quantity, which is assigned to the system and may thus represent the smallest unit of the system, may in this case be designed as a work package. It is further possible that a number of work packages, which together may, for example, produce a synergistic effect, are assigned as a whole to a project within the project landscape. Furthermore, it may be provided that work packages corresponding to a specific type, i.e., having specific properties, may be combined into a work package type for or within one or a plurality of projects. In addition, individual projects may in turn be combined into one project class. It is within the scope of the present invention that a package of work packages may also form a separate system quantity. Furthermore, projects and project classes may also be seen as system quantities for the purposes of the present invention.

It is provided that corresponding delay reasons which are subjected to a Pareto analysis are compiled for the at least one system quantity, thus as a rule a plurality of system quantities. Accordingly, delay Pareto analyses may also be performed for individual projects or project classes, which makes it possible to counteract impending delays early and thus avoid possible delays in the future.

It is thus possible to eliminate continuous delays within a development process of the system or of a project by detecting starting delays (sequential delay analysis, SDA). The detection of ending and starting delay reasons makes it possible to detect the continuity of delay reasons. Delay reasons which are triggered within a system quantity, a work package in particular, are classified as non-critical delay reasons. Delay reasons which affect a plurality of work packages are designated as critical delay reasons. It is possible in one measurement time period to determine and focus on the delay reason, which is most frequently passed on (most critical delay), thus observing it in a particular manner.

A delay which occurs frequently and consequently may always be caused by the same delay reason may ultimately have a negative impact on the entire project or even the entire system or the entire project landscape. The present invention makes it possible to identify a delay of this type and eliminate it before it may be too late. In addition, individual delays having individual delay reasons may also be recognized and analyzed. However, if a delay of this type occurs only once, infrequently or irregularly, this delay may by classified as such using the method according to the present invention.

In a preferred embodiment of the present invention, a development over time of a value of a driver quantity of the system may be calculated, which is a function of at least one value of the at least one system quantity. One system quantity each, in particular a work package, which is assigned to the system may have at least one property and at least one value. The value of the driver quantity may be calculated under consideration of the at least one value of the system quantities, which have at least one specific property.

Driver quantities for a system designed as a project landscape are, for example, relative workload fulfillment (RWF), on-time delivery (OTD), quick digital work package quality (QDQ), the resulting quality of the development process (RPQ), or the relative added value fulfillment (RAVF); according to the present invention, forecasts may be produced for all conceivable driver quantities. Accordingly, the present invention makes it possible to forecast driver quantities based on flexible measurement time periods (maximum achievable fulfillment) (MAF). In order to be able to predict the development of driver quantities and to have the possibility to influence them by intervening, it is practical to predict the best possible fulfillment for one or a plurality of random measurement time periods in the future.

Moreover, it is possible to calculate maximum attainable OTD, RWF, RAVF as well as other driver quantities under consideration of the values of work packages. This makes it possible to optimize the sequence of the system and accordingly of the entire project landscape.

Building on this, it is advantageously possible to evaluate any combination of work packages (work package fail) in an analysis of failure reasons. If, for example, QDQ=0 is specified, a failure reason may be determined from an expanded value inventory. It is now possible to perform a Pareto analysis relating to a project or a project class which makes it possible to focus on the most frequent failure reason. Furthermore, it is possible to perform a Pareto analysis of the failure reasons of individual work package types or of any combination of work package types. Accordingly, the present invention makes it possible to analyze possibly complexly coherent combinations of system quantities or work packages which in their totality may jointly evoke synergistic effects and predict their behavior, in particular their sequences over time, even for the future.

In addition, it is possible to identify critical projects via the “early warning monitor” (EWM). This makes it possible to identify projects which are at risk with respect to time. All deadlines of all work packages of a project are checked for punctuality. If a work package is delayed by a maximum of 25%, for example, it is classified as at risk. A project already having two work packages at risk may already be regarded as critical. A project having only one work package with a maximum 25% delay may be classified as at risk. If a work package is delayed by more than 25%, it is regarded as critical; accordingly, the project to which the work package is assigned must also be considered critical. If the most current work package of a critical path of a project is punctual, the project is also punctual.

The device for measuring a value for a driver quantity of a system, to which a number of units each having at least one property and to which at least one value is assigned, has an electronic computing unit, which calculates the value of the driver quantity under consideration of the at least one value of those units which fulfill a condition based on the at least one property. This device of the present invention makes it possible to calculate the driver quantity as well as to determine the values necessary for the calculation by automation.

The device may have at least one interface for exchanging data between at least two users, databases of the at least two users being synchronized via an automated mechanism. Exchangeable data in this context may be the values of the units or work packages. Since the databases are synchronized via the automated mechanism, a data exchange between service providers and customers as the users may be simplified. An agreement may be made concerning who acts as “master,” i.e., whose database is valid in case of doubt. Depending on the requirements, this synchronization may be assigned any number of complex rules.

The method according to the present invention may be used in particular to detect problems which occur at the interfaces.

This is significant because a delay which may occur within a work package or a project of one user may also impact a project of another user via the interface.

Dynamic resource management (DRM) is made possible in this manner. A customer as the one user and a service provider as the other user are thus synchronized via this interface, thereby ensuring transparency. The customer is able to see if an ordered process, which by analogy may correspond to a work package or a project, was already started or has already been delayed since both plan data as well as actual data are available. This enables the customer to adjust planning at any time.

The computer program of the present invention having program code means is used to implement all steps of the method according to the present invention when this computer program is run on a corresponding electronic computing unit of the device of the present invention. The driver quantities, which, for example, may also be actual values, delays or delay reasons, may thus be calculated in a simple manner with a low time expenditure. Software connected with the computer program may be flexible with respect to its measurement setting and a use for a project group, which may have a number of units or work packages. Thus, any type of project or sequence of work packages may be tracked and measured. However, an unambiguous standard prevails within a project group, which may include several projects, as a result of the software defined by the computer program.

The computer program of the present invention may be designed as a software module and have a number of versions and may start a version provided for the measurement of the specific driver quantity via a version edition loaded from an initial file for calculating a specific driver quantity, which may, for example, also be an actual value, delay, or delay reason. Thus the particular correct version is started automatically as a function of a property of the driver quantity or as a function of the driver quantity. This version may be treated internally as a global variable.

The computer program of the present invention may have supplemental software for an exchange of data with another system, this software being able to change at least one driver quantity as needed as a function of a change of user data. It is thus possible to exchange data with other systems, planning systems in particular. Based on an automatic feedback for the system, the driver quantities are automatically influenced when customer data and service provider data are changed. In turn, it is thus possible to enable early counteractions.

It is understood that the features stated above and the features still to be explained below are usable not only in the particular combination specified but also in other combinations or alone without departing from the scope of the present invention.

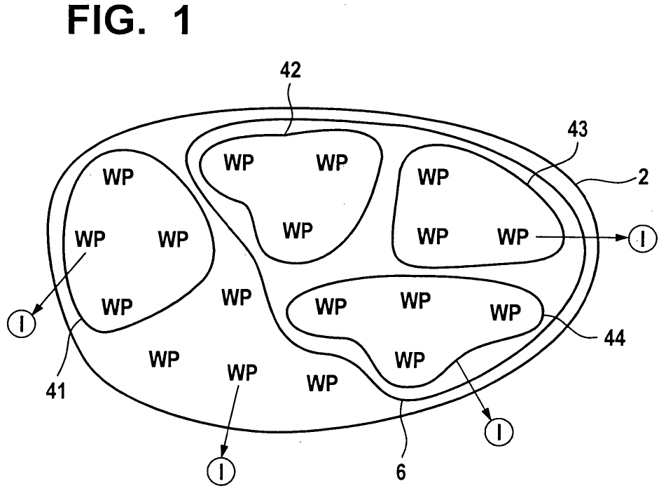

FIG. 1 shows a schematic representation of a system designed as a project landscape 2, to which a number of system quantities designed as work packages WP are assigned. Within project landscape 2, a plurality of work packages WP may be combined into a project 41, 42, 43, or 44. Furthermore, a plurality of projects 42, 43, 44 may be combined into a project class 6. Purely conceptually, work packages WP as well as projects 41, 42, 43, 44 and a project class 6 within project landscape 2 are identified as system quantities.

A property of a work package WP may, for example, be characterized by its sequence over time. During this sequence over time, at least one event may occur. If this event is subject to a delay, it is not possible to detect it. On this basis, at least one actual value I over time may be calculated for the at least one event of the at least one work package WP or in general at least one system quantity within a measurement time period to be predicted. It is thus possible to predict a development over time of a work package WP within a project 41, 42, 43, 44 of project class 6 or of entire project landscape 2 by detecting the associated delay and calculating associated actual value I. In one possible embodiment, it is thus also possible to calculate a prediction for a development over time of a value of a driver quantity, which, for example, may also depend on a course of at least one work package.

The present invention thus provides an instrument which makes future planning possible for a project landscape 2 or for one of associated projects 41, 42, 43, 44 of project class 6 or of project landscape 2; of course, this is also possible for all other system quantities within the system designed as project landscape 2. This prediction makes effective resource management possible. Errors, which may be caused by delays and which may thus endanger a smooth sequence of at least one of projects 41, 42, 43, 44 are thus identified early. For that reason, it is possible to take at least one measure to avoid such delays by early counteraction.

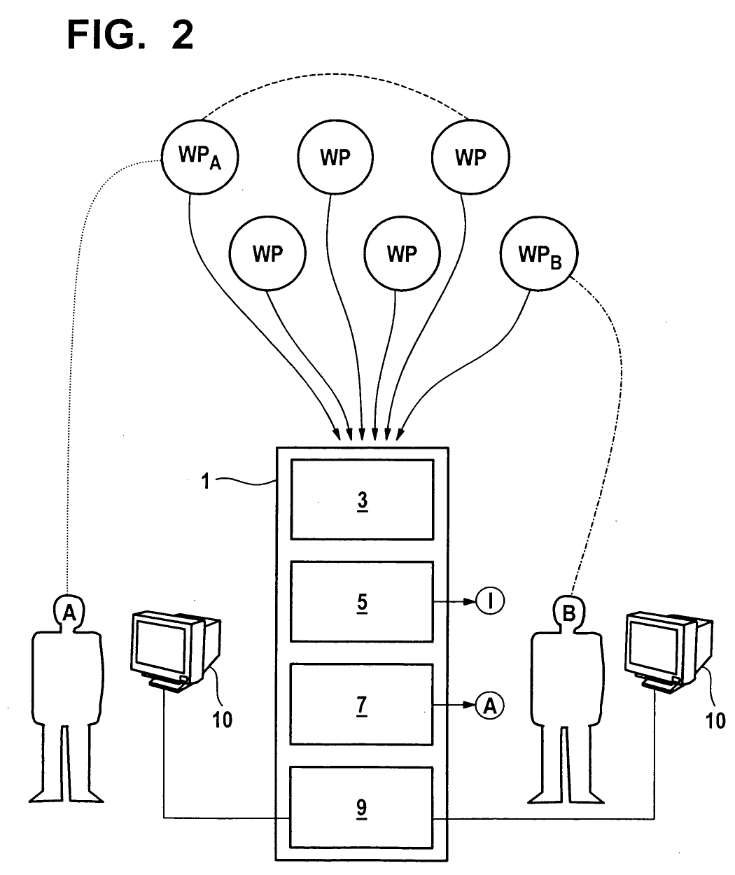

FIG. 2 shows a schematic representation of among other things a device 1 of the present invention for implementing the method according to the present invention. Device 1 has a detector unit 3, an electronic computing unit 5, an analyzer unit 7, as well as an interface 9.

It is provided that computers 10 or other suitable data exchange or communication devices of two users A and B are connected via interface 9. Both users A and B may exchange data via interface 9, it being possible to synchronize databases of both users A and B via an automated mechanism.

A work package WP_{A} may be influenced by actions of user A and/or affect his/her interests (dotted line). In a comparable manner, work package WP_{B} may be influenced by actions of user B and/or affect his/her interests (dot-dash line). The two work packages WP_{A} and WP_{B} may be connected by reciprocal action and thus mutually influence one another (dashed line). The two users A and B may obtain information concerning the effects of this reciprocal action by data exchange via interface 9; an influencing is possible via interface 9 by entering or changing data.

Sequences of various work packages WP, which may be characterized by a sequence of events, may be detected by detection unit 3 within device 1. Based on this, electronic computing unit 5 makes it possible to delay an event of one of work packages WP. Based on delays of events of work packages WP, according to the present invention, it is also possible to use electronic computing unit 5 to calculate or predict a, for example, future actual value I over time for an event. Instead of this actual value I, it is also possible to calculate a driver quantity. Analyzer unit 7 may accordingly be used to analyze already provided knowledge concerning the project landscape or one or a plurality of work packages WP. From a development over time of work package WP, which is calculable according to the present invention, it is consequently possible to determine an analytic result A, so that it is also possible, for example, to determine a maximally achievable value for the driver quantity.

For the delays, analyzer unit 7 may be used to assign delay reasons. In this case also, a plurality of possibly related delay reasons may be analyzed as a whole and thus a meaningful analytic result A may also be provided for a future behavior in particular of a project to which a plurality of work packages WP are assigned.

1. A method for predicting a development over time of a system quantity (WP, 41, 42, 43, 44, 6) of a system (2), to which a number of system quantities (WP, 41, 42, 43, 44, 6) are assigned, a sequence in each case of one of the system quantities (WP, 41, 42, 43, 44, 6) being characterized by at least one event, comprising detecting a delay of the at least one event and, based on it, calculating at least one actual value (I) over time for at least one event of at least one system quantity (WP, 41, 42, 43, 44, 6) within a measurement time period to be predicted.

2. The method according to claim 1, in which the at least one actual value (I) is calculated in consideration of at least one time buffer between at least two system quantities (WP, 41, 42, 43, 44, 6).

3. The method according to claim 1, in which a delay reason is assigned to the delay from a number of predetermined, system-specific delay reasons.

4. The method according to claim 2, in which a delay reason is assigned to the delay from a number of predetermined, system-specific delay reasons.

5. The method according to claim 1, in which for the at least one system quantity (WP, 41, 42, 43, 44, 6), a number of delay reasons are combined and subjected to a Pareto analysis.

6. The method according to claim 2, in which for the at least one system quantity (WP, 41, 42, 43, 44, 6), a number of delay reasons are combined and subjected to a Pareto analysis.

7. The method according to claim 3, in which for the at least one system quantity (WP, 41, 42, 43, 44, 6), a number of delay reasons are combined and subjected to a Pareto analysis.

8. The method according to claim 1, in which a prediction is produced for a development over time of a value of a driver quantity of the system, which is a function of at least one value of the at least one system quantity (WP, 41, 42, 43, 44, 6).

9. The method according to claim 2, in which a prediction is produced for a development over time of a value of a driver quantity of the system, which is a function of at least one value of the at least one system quantity (WP, 41, 42, 43, 44, 6).

10. The method according to claim 3, in which a prediction is produced for a development over time of a value of a driver quantity of the system, which is a function of at least one value of the at least one system quantity (WP, 41, 42, 43, 44, 6).

11. The method according to claim 5, in which a prediction is produced for a development over time of a value of a driver quantity of the system, which is a function of at least one value of the at least one system quantity (WP, 41, 42, 43, 44, 6).

12. The method according to claim 1, which can be implemented for a system quantity designed as a work package (WP) as the smallest unit of a system designed as a project landscape (2), as well as for a system quantity designed as a project (41, 42, 43, 44), to which a number of work packages (WP) are assigned, as well as for a system quantity designed as a project class (6), to which a number of projects (41, 42, 43, 44) are assigned.

13. The method according to claim 2, which can be implemented for a system quantity designed as a work package (WP) as the smallest unit of a system designed as a project landscape (2), as well as for a system quantity designed as a project (41, 42, 43, 44), to which a number of work packages (WP) are assigned, as well as for a system quantity designed as a project class (6), to which a number of projects (41, 42, 43, 44) are assigned.

14. The method according to claim 3, which can be implemented for a system quantity designed as a work package (WP) as the smallest unit of a system designed as a project landscape (2), as well as for a system quantity designed as a project (41, 42, 43, 44), to which a number of work packages (WP) are assigned, as well as for a system quantity designed as a project class (6), to which a number of projects (41, 42, 43, 44) are assigned.

15. A device for predicting a development over time of a system quantity (WP, 41, 42, 43, 44, 6) of a system (2), to which a number of system quantities (WP, 41, 42, 43, 44, 6) are assigned, a sequence in each case of one of the system quantities (WP, 41, 42, 43, 44, 6) being characterized by at least one event, comprising at least one electronic device (3) which detects a delay of the at least one event, and at least one electronic computing unit (10) which, based on said delay, calculates at least one actual value (I) over time for at least one event of at least one system quantity (WP, 41, 42, 43, 44, 6) within a measurement time period to be predicted.

16. The device according to claim 15, further comprising at least one interface (9) for exchanging data between at least two users (A, B), databases of the at least two users (A, B) being synchronized via an automated mechanism.

17. A computer program having program code means for implementing the method according to claim 1 when the computer program is run on a computer or a corresponding electronic computing unit(9).

18. The computer program according to claim 17, which is designed as a software module, has a number of versions, and starts a version provided for measuring the specific driver quantity via a version edition loaded from an initial file for calculating a value of a specific driver quantity.

19. The computer program according to claim 17, which has supplemental software for an exchange of data with another system which, if necessary, changes at least one driver quantity as a function of a change of data of a user.

20. A computer program product having program code means, which are stored on a computer-readable data medium, for implementing the method according to claim 1.
